(19) United States
(12) Patent Application Publication
(10) Pub. No.: US 2020/0128331 A1
(43) Pub. Date: Apr. 23, 2020

(54) VIBRATION REDUCTION MOVING COIL SPEAKER

(71) Applicant: GM GLOBAL TECHNOLOGY OPERATIONS LLC, Detroit, MI (US)

(72) Inventors: Ian R. Singer, Macomb, MI (US); Dargham Alyassiry, Dearborn Heights, MI (US)

(21) Appl. No.: 16/167,222

(22) Filed: Oct. 22, 2018

(51) Int. Cl. H04R 9/06; H04R 9/04; H04R 9/02; H04R 7/12

(52) U.S. Cl. CPC H04R 9/06; H04R 9/046; H04R 2400/11; H04R 7/127; H04R 9/025

(57) ABSTRACT

A moving coil speaker may comprise a frame, a magnet assembly fixedly mounted to the frame and having a central axis, first and second annular gaps defined by the magnet assembly and concentrically disposed about the central axis, a voice coil at least partially received within the first annular gap, a cone coupled to and driven by the voice coil, a secondary coil at least partially received within the second annular gap, and a mass coupled to and driven by the secondary coil. When variable electrical audio signals are sent from an audio signal source respectively through the voice coil and the secondary coil, the coils and their respectively associated cone and mass reciprocate back and forth in opposite axial directions, with the reciprocal movement of the cone being counterbalanced by the reciprocal movement of the mass.

### INTRODUCTION

A moving coil speaker typically includes a diaphragm or cone attached to a coil of wire (referred to as a voice coil) suspended in a narrow annular gap in a magnetic field generated by a permanent magnet. When variable electrical audio signals, in the form of alternating electric currents, are applied to the voice coil, a variable magnetic field is generated around the voice coil that interacts with the magnetic field generated by the permanent magnet and forces the voice coil to reciprocate back and forth within the annular gap. The back and forth movement of the voice coil is transferred to the attached cone, which is driven outward and pulled inward under the control of the electrical audio signals applied to the voice coil. This back and forth movement of the cone pushes or pulls surrounding air, which translates the variable electrical audio signals into audible sound waves.

The sound waves produced by the cone of the speaker oftentimes impart reactionary forces on the speaker itself, which may generate mechanical vibrations in the speaker. In turn, these mechanical vibrations may be transferred to a supporting structure, frame, or enclosure of the speaker, and may produce unwanted noise, e.g., buzz, squeak, or rattle. Therefore, there is a need in the art for a method of reducing or eliminating the reactionary forces imparted on the speaker during operation thereof to, in turn, reduce or eliminate undesirable mechanical vibrations and noise.

### SUMMARY

According to one aspect of the invention, there is provided a moving coil speaker. The speaker may comprise a frame and a magnet assembly fixedly mounted to the frame. The magnet assembly may have a central axis, a front end, and an opposite back end, and may include an annular permanent magnet disposed around the central axis. First and second annular gaps may be concentrically disposed around the central axis. The first annular gap may be defined by the front end of the magnet assembly and the second annular gap may be defined by the back end of the magnet assembly. A voice coil may be at least partially received within the first annular gap, and a cone may be coupled to and driven by the voice coil. A secondary coil may be at least partially received within the second annular gap, and a mass may be coupled to and driven by the secondary coil. An audio signal source may be electrically coupled to the voice coil and the secondary coil. The audio signal source, the voice coil, and the secondary coil may be constructed and arranged such that, when variable electrical audio signals are directed from the audio signal source respectively through the voice coil and the secondary coil, the coils and their respectively associated cone and mass reciprocate back and forth in opposite axial directions, with the reciprocal movement of the cone being counterbalanced by the reciprocal movement of the mass.

In one form, the voice coil and the secondary coil may be wound in opposite directions around respective first and second coil formers. In such case, the audio signal source may be electrically coupled to the voice coil and the secondary coil such that the variable electrical audio signals received by the voice coil are in phase with the variable electrical audio signals received by the secondary coil.

In another form, the voice coil and the secondary coil may be wound in the same direction around respective first and second coil formers. In such case, the audio signal source may be electrically coupled to the voice coil and the secondary coil such that the variable electrical audio signals received by the voice coil are 180 degrees out of phase with the variable electrical audio signals received by the secondary coil.

In one embodiment, the magnet assembly may include a front plate, a back plate, a center pole piece, and a peripheral pole piece. The front plate may be adjacent the front end of the magnet assembly and the back plate may be adjacent the back end of the magnet assembly. The center pole piece may extend along the central axis, and the peripheral pole piece may extend from the front end toward the back end of the magnet assembly. In such case, the annular permanent magnet may be sandwiched between the front and back plates, the center pole piece may be surrounded by the annular permanent magnet and the front plate, and the peripheral pole piece may extend around an outer periphery of the annular permanent magnet.

The first annular gap may be defined between an inner circumferential surface of the front plate and an outer circumferential surface of the center pole piece, and the second annular gap may be defined between an inner circumferential surface of the peripheral pole piece and an outer circumferential surface of the back plate.

Magnetic flux generated by the annular permanent magnet may travel in a first direction from the magnet, through the back plate, through the center pole piece, across the first annular gap, through the front plate, and back into the magnet. In addition, magnetic flux generated by the annular permanent magnet may travel in a second direction opposite the first direction from the magnet, through the back plate, across the second annular gap, through the peripheral pole piece, through the front plate, and back into the magnet.

In one form, the center pole piece and the back plate may be of integral, one-piece construction, and the peripheral pole piece and the front plate may be of integral, one-piece construction.

In another embodiment, the magnet assembly may include a front plate, a back plate, and a center pole piece including a cylindrical permanent magnet. The front plate may be adjacent the front end of the magnet assembly and the back plate may be adjacent the back end of the magnet assembly. In such case, the annular permanent magnet may be sandwiched between the front and back plates, and the center pole piece may be surrounded by the annular permanent magnet and the front plate.

In one form, the center pole piece may include a first end adjacent the back plate, an opposite second end adjacent the front plate, and a pair of concentric inner and outer pole pieces connected to each other at the second end by a bridge. The outer pole piece may extends from the first end to the second end of the center pole piece and at least partway through the front plate. The inner pole piece may extend along the central axis from a proximal end adjacent the second end of the center pole piece to a distal end adjacent the first end of the center pole piece. The distal end of the inner pole piece may extend at least partway through the back plate. The cylindrical permanent magnet may be positioned along the central axis between the proximal and distal ends of the inner pole piece.

The first annular gap may be defined between an inner circumferential surface of the front plate and an outer circumferential surface of the outer pole piece. The second annular gap may be defined between an inner circumferential surface of the outer pole piece and an outer circumferential surface of the inner pole piece.

In one form, the center pole piece and the back plate may be of integral, one-piece construction,

The cylindrical permanent magnet may have the same magnetic orientation as that of the annular permanent magnet.

Magnetic flux generated by the annular permanent magnet may travel from the annular permanent magnet, through the front plate, across the first annular gap, through the outer pole piece of the center pole piece, through the back plate, and back into the annular permanent magnet. Magnetic flux generated by the cylindrical permanent magnet may travel from the cylindrical permanent magnet, through the proximal end of the inner pole piece, through the bridge, through the outer pole piece, across the second annular gap, through the distal end of the inner pole piece, and back into the cylindrical permanent magnet.

The magnetic flux respectively generated by the annular permanent magnet and the cylindrical permanent magnet may travel along a shared path through the outer pole piece of the center pole piece.

According to another aspect of the invention, there is provided a moving coil speaker comprising a frame and a magnet assembly fixedly mounted to the frame. The magnet assembly may have a central axis, a front end, and an opposite back end. The magnet assembly may include an annular permanent magnet disposed around the central axis, a front plate, a back plate, a center pole piece, and first and second annular gaps concentrically disposed around the central axis. The front plate may be adjacent the front end of the magnet assembly and the back plate may be adjacent the back end of the magnet assembly. The center pole piece may extend between the front and back ends of the magnet assembly along the central axis and at least part-way through a central opening in the front plate. The first annular gap may be defined by the front end of the magnet assembly and the second annular gap may be defined by the back end of the magnet assembly. A voice coil may be at least partially received within the first annular gap. A cone may be coupled to and driven by the voice coil. A secondary coil may be at least partially received within the second annular gap. A mass may be coupled to and driven by the secondary coil. An audio signal source may be electrically coupled to the voice coil and the secondary coil. The annular permanent magnet may be sandwiched between the front and back plates and the center pole piece may be surrounded by the annular permanent magnet and the front plate. The voice coil and the secondary coil may be constructed and arranged such that, when variable electrical audio signals are directed from the audio signal source respectively through the voice coil and the secondary coil, the coils and their respectively associated cone and mass reciprocate back and forth in opposite axial directions, with the reciprocal movement of the cone being counterbalanced by the reciprocal movement of the mass.

In one form, the speaker may comprise a peripheral pole piece extending around an outer periphery of the annular permanent magnet and extending in an axial direction from the front plate toward the back plate. In such case, the first annular gap may be defined between an inner circumferential surface of the front plate and an outer circumferential surface of the center pole piece and the second annular gap may be defined between an inner circumferential surface of the peripheral pole piece and an outer circumferential surface of the back plate. Magnetic flux generated by the annular permanent magnet may travel in a first direction through the front and back plates, the center pole piece, and across the first annular gap, and magnetic flux generated by the annular permanent magnet may travel in a second direction opposite the first direction through the front and back plates, the peripheral pole piece, and across the second annular gap.

In one form, the magnet assembly may comprise a cylindrical permanent magnet. In such case, the center pole piece may include a first end adjacent the back plate, an opposite second end adjacent the front plate, and a pair of concentric inner and outer pole pieces extending between the first and second ends. The first annular gap may be defined between an inner circumferential surface of the front plate and an outer circumferential surface of the outer pole piece. The second annular gap may be defined between an inner circumferential surface of the outer pole piece and an outer circumferential surface of the inner pole piece. The cylindrical permanent magnet may be disposed along the central axis between the first and second ends of the center pole piece.

Magnetic flux generated by the annular permanent magnet may travel through the front and back plates, the outer pole piece of the center pole piece, and across the first annular gap. Magnetic flux generated by the cylindrical permanent magnet may travel through the inner and outer pole pieces of the center pole piece and across the second annular gap. The magnetic flux respectively generated by the annular permanent magnet and the cylindrical permanent magnet may travel along a shared path through the outer pole piece of the center pole piece.

### BRIEF DESCRIPTION OF THE DRAWINGS

One or more embodiments of the invention will hereinafter be described in conjunction with the appended drawings, wherein like designations denote like elements, and wherein:

FIG. 1 is a schematic cross-sectional side view of a moving coil speaker including an annular permanent magnet, a system of pole pieces, a cone coupled to and driven by a voice coil received within a first annular gap, and a mass coupled to and driven by a secondary coil received within a second annular gap;

FIG. 2 is an enlarged partial cross-sectional side view of the moving coil speaker of FIG. 1 depicting magnetic flux lines generated by the annular permanent magnet;

FIG. 3 is a schematic cross-sectional side view of another moving coil speaker including an annular permanent magnet, a cylindrical permanent magnet, a system of pole pieces, a cone coupled to and driven by a voice coil received within a first annular gap, and a mass coupled to and driven by a secondary coil received within a second annular gap;

FIG. 4 is an enlarged partial cross-sectional side view of the moving coil speaker of FIG. 3; and

FIG. 5 is an enlarged partial cross-sectional side view of the moving coil speaker of FIG. 3 depicting magnetic flux lines generated by the annular permanent magnet and the cylindrical permanent magnet.

### DETAILED DESCRIPTION

The moving coil speakers described herein include a cone coupled to and driven by a voice coil and a mass coupled to and driven by a secondary coil. The cone and the mass are driven in opposite axial directions during operation of the speaker such that the axial movement of the cone is counterbalanced by the axial movement of the mass, which reduces or eliminates the net force imparted on the speaker during operation thereof. Reducing or eliminating the net force imparted on the speaker during operation can, in turn, reduce or eliminate the generation of mechanical vibrations in the speaker and the transfer of such vibrations to support structures fixedly attached thereto.

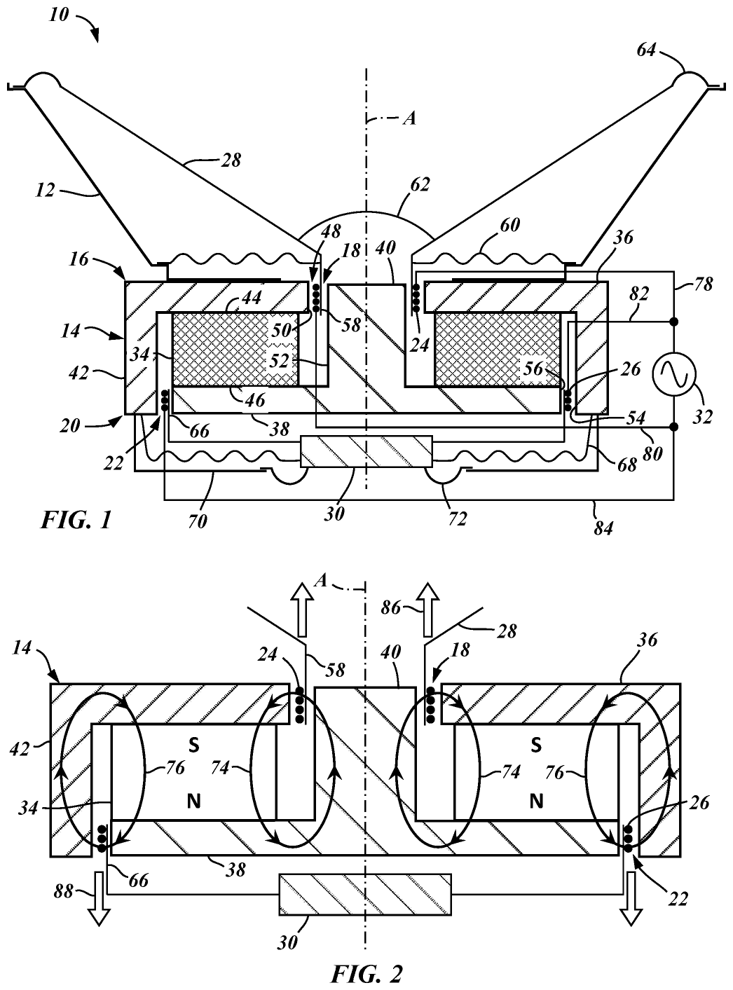

FIGS. 1 and 2 illustrate a moving coil speaker 10, in accordance with one or more embodiments of the present disclosure. The speaker 10 has a central axis A and includes a rigid frame 12, a magnet assembly 14 having a front end 16 that defines a first annular gap 18 and an opposite back end 20 that defines a second annular gap 22, a voice coil 24 at least partially received within the first annular gap 18, a secondary vibration reduction coil 26 at least partially received within the second annular gap 22, a cone 28 coupled to and driven by the voice coil 24, a mass 30 coupled to and driven by the secondary coil 26, and an audio signal source 32 electrically coupled to the voice coil 24 and the secondary coil 26.

The magnet assembly 14 is fixedly mounted to the rigid frame 12 and includes an annular permanent magnet 34, a front plate 36, a back plate 38, a center pole piece 40, and a peripheral pole piece 42. The annular permanent magnet 34 is concentric about the central axis A and includes a front face 44 that faces toward the front end 16 of the assembly 14 and an opposite back face 46 that faces toward the back end 20 of the assembly 14. The front plate 36 is located at the front end 16 of the assembly 14 and is positioned adjacent the front face 44 of the magnet 34. The back plate 38 is located at the back end 20 of the assembly 14 and is positioned adjacent the back face 46 of the magnet 34. As such, the magnet 34 is sandwiched between the front and back plates 36, 38. The front plate 36 includes a central opening 48 defined by an inner circumferential surface 50 of the front plate 36. The center pole piece 40 is surrounded by the magnet 34 and the front plate 36 and extends along the central axis A of the speaker 10, from the back plate 38 toward the front end 16 of the assembly 14, and at least part-way through the central opening 48 in the front plate 36. In one form, the center pole piece 40 and the back plate 38 may be of integral, one-piece construction. The peripheral pole piece 42 surrounds the magnet 34 and extends in an axial direction from the front plate 36 at the front end 16 of the assembly 14 toward the back plate 38 at the back end 20 of the assembly 14. In one form, the front plate 36 and the peripheral pole piece 42 may be of integral, one-piece construction.

The first annular gap 18 is defined between the inner circumferential surface 50 of the front plate 36 and an outer circumferential surface 52 of the center pole piece 40. The second annular gap 22 is coaxial with the first annular gap 18 and is defined between an inner circumferential surface 54 of the peripheral pole piece 42 and an outer periphery 56 of the back plate 38. The plates 36, 38 and pole pieces 40, 42 are constructed and arranged so as to concentrate the magnetic flux generated by the annular permanent magnet 34 within the first and second annular gaps 18, 22. In particular, as best shown in FIG. 2, the front plate 36, back plate 38, and center pole piece 40 are constructed and arranged so that magnetic flux generated by the magnet 34 travels in a first direction and follows a path 74 from the magnet 34 through the back plate 38, through the center pole piece 40, through the first annular gap 18, through the front plate 36, and back into the magnet 34. At the same time, the front plate 36, peripheral pole piece 42, and back plate 38 are constructed and arranged so that magnetic flux generated by the magnet 34 travels in a second direction opposite the first direction and follows a path 76 from the magnet 34 through the back plate 38, through the second annular gap 22, through the peripheral pole piece 42, through the front plate 36, and back into the magnet 34.

The voice coil 24 is flexibly supported within the first annular gap 18 so that the coil 24 can move back and forth in an axial direction within the gap 18 during operation of the speaker 10. The voice coil 24 is fixedly coupled to and wound around a first coil former 58, which is fixedly coupled to an apex of the cone 28. The coil former 58 may be supported in concentric alignment with the central axis A of the speaker 10 by a damper or spider 60, which may be flexibly coupled to the rigid frame 12. In one form, a dust cover 62 may be positioned on the cone 28 to help keep air, dust, and debris out of the speaker 10. The cone 28 may be flexibly coupled to the rigid frame 12 at an outer periphery thereof by a flexible surround 64, which may allow the cone 28 to move back and forth relative to the frame 12 during operation of the speaker 10.

The secondary coil 26 is coaxial with the voice coil 24 and is flexibly supported within the second annular gap 22 so that the coil 26 can move back and forth in an axial direction in the gap 22 during operation of the speaker 10. The secondary coil 26 is fixedly coupled to and wound around a second coil former 66, which is fixedly coupled to the mass 30. The coil former 66 may be supported in concentric alignment with the central axis A of the speaker 10 by a damper or spider 68, which may be coupled to the magnet assembly 14, e.g., the peripheral pole piece 42. In one form, the mass 30 may be flexibly coupled to another rigid frame 70 at an outer periphery thereof by another flexible surround 72, which may allow the mass 30 to move back and forth relative to the frame 70 and the magnet assembly 14.

The audio signal source 32 is electrically coupled to the voice coil 24 via a first pair of wires 78, 80 and is electrically coupled to the secondary coil 26 via a second pair of wires 82, 84. During operation of the speaker 10, variable electrical audio signals, in the form of alternating currents, are directed from the audio signal source 32 respectively through the first and second pairs of wires 78, 80, 82, 84 and through the voice coil 24 and secondary coil 26. When the variable electrical audio signals are sent from the audio signal source 32 through the voice coil 24, a variable magnetic field is generated around the coil 24, which causes the voice coil 24 and its associated cone 28 to reciprocate back and forth relative to the magnet assembly 14 and thereby translate the variable frequency and amplitude of the electrical audio signals into mechanical movement in the form of a series of compression waves produced by the cone 28 and perceived as sound.

The secondary coil 26 also receives variable electrical audio signals from the audio signal source 32 during operation of the speaker 10, which cause the secondary coil 26 and the mass 30 to reciprocate back and forth relative to the magnet assembly 14. However, the speaker 10 is configured so that the reciprocal movement of the mass 30 is 180 degrees out of phase with the movement of the cone 28, meaning that the mass 30 always moves in an opposite axial direction relative to the axial movement of the cone 28, as shown by arrows 86, 88 in FIG. 2. Although the arrows 86, 88 depict the cone 28 moving in a first axial direction away from the magnet assembly 14 and the mass 30 moving in a second axial direction opposite the first axial direction, in practice the cone 28 and mass 30 will both reciprocate back and forth in the first and second axial directions, but the axial movement of the cone 28 will always be in the opposite axial direction as that of the mass 30. Because the cone 28 and the mass 30 are always moving in opposite axial directions, the reciprocal movement of the cone 28 is always counterbalanced by the reciprocal movement of the mass 30, which effectively reduces or eliminates the net force exerted on the frame 12 during operation of the speaker 10. Reducing or eliminating the net force exerted on the frame 12 helps eliminate vibration of the frame 12 and of any components attached thereto.

In one form, the mass 30 may be controlled to move out of phase relative to the movement of the cone 28 by respectively winding the voice coil 24 and the secondary coil 26 in the same direction around the first and second coil formers 58, 66 and sending inverse variable electrical audio signals to the secondary coil 26 that are 180 degrees out of phase with the variable electrical audio signals sent to the voice coil 24. In another form, the mass 30 may be controlled to move out of phase relative to the movement of the cone 28 by respectively winding the voice coil 24 and the secondary coil 26 is opposite directions around the first and second coil formers 58, 66 and passing the same variable electrical audio signals through the voice coil 24 and the secondary coil 26 at the same time.

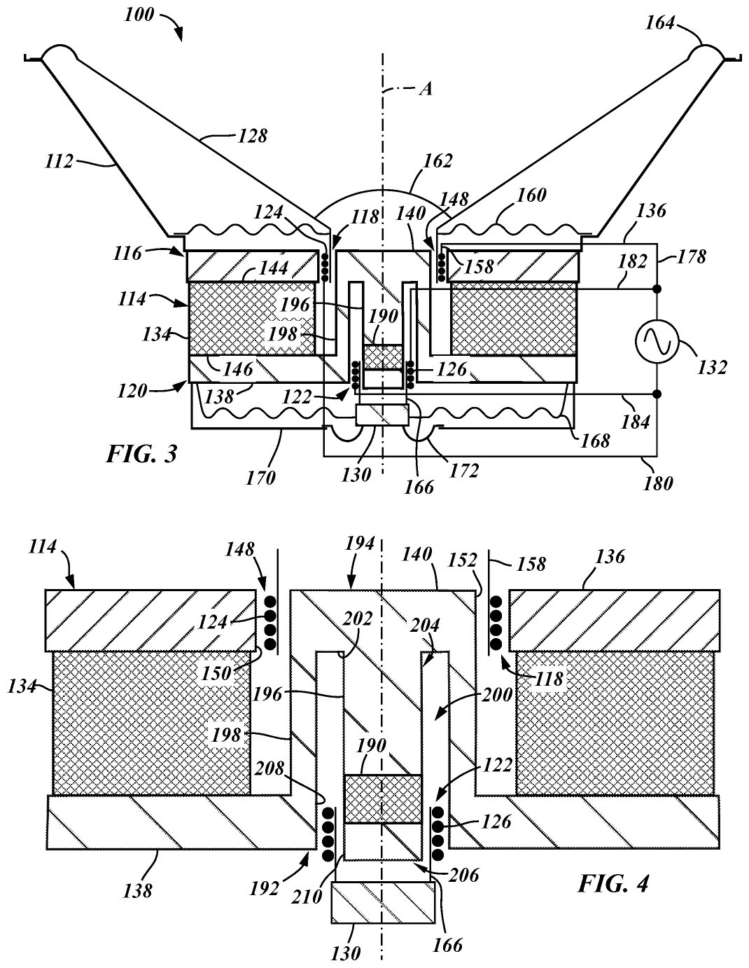

FIGS. 3, 4, and 5 illustrate another moving coil speaker 100, in accordance with one or more embodiments of the present disclosure. The speaker 100 depicted in FIGS. 3, 4, and 5 is similar in many respects to the speaker 10 of FIGS. 1 and 2 and like numerals between the embodiments generally designate like or corresponding elements throughout the several views of the drawing figures. Subject matter common to the embodiments generally may not be repeated here.

The speaker 100 has a central axis A and includes a rigid frame 112, a magnet assembly 114 having a front end 116 that defines a first annular gap 118 and an opposite back end 120 that defines a second annular gap 122, a voice coil 124 at least partially received within the first annular gap 118, a secondary vibration reduction coil 126 at least partially received within the second annular gap 122, a cone 128 coupled to and driven by the voice coil 124, a mass 130 coupled to and driven by the secondary coil 126, and an audio signal source 132 electrically coupled to the voice coil 124 and the secondary coil 126.

The magnet assembly 114 is fixedly mounted to the rigid frame 112 and includes an annular permanent magnet 134, a front plate 136, a back plate 138, and a center pole piece 140 including a cylindrical permanent magnet 190. The annular permanent magnet 134 is concentric about the central axis A and includes a front face 144 that faces toward the front end 116 of the assembly 114 and an opposite back face 146 that faces toward the back end 120 of the assembly 114. The front plate 136 is located at the front end 116 of the assembly 114 and is positioned adjacent the front face 144 of the magnet 134. The back plate 138 is located at the back end 120 of the assembly 114 and is positioned adjacent the back face 146 of the magnet 134. As such, the magnet 134 is sandwiched between the front and back plates 136, 138. The front plate 136 includes a central opening 148 defined by an inner circumferential surface 150 of the front plate 136.

As best shown in FIG. 4, the center pole piece 140 extends along the central axis A and is surrounded by the magnet 134 and the front plate 136. The center pole piece 140 includes a first end 192 adjacent the back plate 138, an opposite second end 194 adjacent the front plate 136, and a pair of concentric inner and outer pole pieces 196, 198. The inner and outer pole pieces 196, 198 are separated from each other by an annular cavity 200 and are connected to each other at the second end 194 by a bridge 202.

The outer pole piece 198 extends from the first end 192 to the second end 194 of the center pole piece 140 and at least part-way through the central opening 148 in the front plate 136. The inner pole piece 196 extends along the central axis A of the speaker 100 from a proximal end 204 adjacent the second end 194 of the center pole piece 140 to a distal end 206 adjacent the first end 192 of the center pole piece 140. The distal end 206 of the inner pole piece 196 may extend at least part-way through the back plate 138. The cylindrical permanent magnet 190 is positioned along the central axis A between the proximal and distal ends 204, 206 of the inner pole piece 196. In one form, the center pole piece 140 and the back plate 138 may be of integral, one-piece construction.

The first annular gap 118 is defined between the inner circumferential surface 150 of the front plate 136 and an outer circumferential surface 152 of the outer pole piece 198 of the center pole piece 140. The second annular gap 122 is coaxial with the first annular gap 118 and is defined between an inner circumferential surface 208 of the outer pole piece 198 and an outer circumferential surface 210 of the inner pole piece 196 of the center pole piece 140.

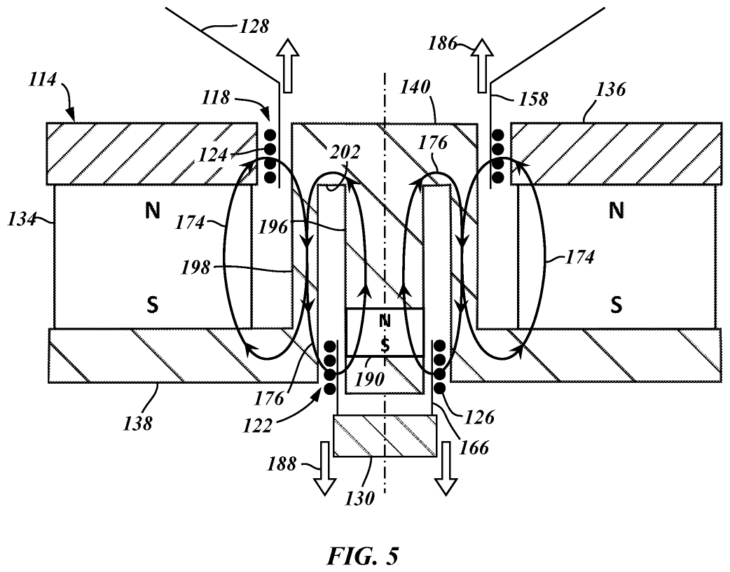

The front and back plates 136, 138 and the center pole piece 140 are constructed and arranged so as to concentrate the magnetic flux generated by the annular permanent magnet 134 and the cylindrical permanent magnet 190 within the first and second annular gaps 118, 122. In particular, as best shown in FIG. 5, the front plate 136, back plate 138, and the outer pole piece 198 of the center pole piece 140 are constructed and arranged so that magnetic flux generated by the annular permanent magnet 134 follows a path 174 from the magnet 134 through the front plate 136, across the first annular gap 118, through the outer pole piece 198 of the center pole piece 140, through the back plate 138, and back into the magnet 134. At the same time, the center pole piece 140 is constructed and arranged so that magnetic flux generated by the cylindrical permanent magnet 190 follows a path 176 from the magnet 190, through the proximal end 204 of the inner pole piece 196, through the bridge 202, through the outer pole piece 198, across the second annular gap 122, through the distal end 206 of the inner pole piece 196, and back into the magnet 190.

The voice coil 124 is flexibly supported within the first annular gap 118 so that the coil 124 can move back and forth in an axial direction within the gap 118 during operation of the speaker 100. The voice coil 124 is fixedly coupled to and wound around a first coil former 158, which is fixedly coupled to an apex of the cone 128. The coil former 158 may be supported in concentric alignment with the central axis A of the speaker 100 by a damper or spider 160, which may be flexibly coupled to the rigid frame 112. In one form, a dust cover 162 may be positioned on the cone 128 to help keep air, dust, and debris out of the speaker 100. The cone 128 may be flexibly coupled to the rigid frame 112 at an outer periphery thereof by a flexible surround 164, which may allow the cone 128 to move back and forth relative to the frame 112 during operation of the speaker 100.

The secondary coil 126 is coaxial with the voice coil 124 and is flexibly supported within the second annular gap 122 so that the coil 126 can move back and forth in an axial direction in the gap 122 during operation of the speaker 100. The secondary coil 126 is fixedly coupled to and wound around a second coil former 166, which is fixedly coupled to the mass 130. The coil former 166 may be supported in concentric alignment with the central axis A of the speaker 100 by a damper or spider 168, which may be coupled to the magnet assembly 114, e.g., the back plate 138. In one form, the mass 130 may be flexibly coupled to another rigid frame 170 at an outer periphery thereof by another flexible surround 172, which may allow the mass 130 to move back and forth relative to the frame 170 and the magnet assembly 114.

The audio signal source 132 is electrically coupled to the voice coil 124 via a first pair of wires 178, 180 and is electrically coupled to the secondary coil 126 via a second pair of wires 182, 184. During operation of the speaker 100, variable electrical audio signals, in the form of alternating currents, are directed from the audio signal source 132 respectively through the first and second pairs of wires 178, 180, 182, 184 and through the voice coil 124 and secondary coil 126. When the variable electrical audio signals are sent from the audio signal source 132 through the voice coil 124, a variable electromagnetic field is generated around the coil 124, which causes the voice coil 124 and its associated cone 128 to reciprocate back and forth relative to the magnet assembly 114 and thereby translate the variable frequency and amplitude of the electrical audio signals into mechanical movement in the form of a series of compression waves produced by the cone 128 and perceived as sound.

The secondary coil 126 also receives variable electrical audio signals from the audio signal source 132 during operation of the speaker 100, which cause the secondary coil 126 and the mass 130 to reciprocate back and forth relative to the magnet assembly 114. However, the speaker 100 is configured so that the reciprocal movement of the mass 130 is 180 degrees out of phase with the movement of the cone 128, meaning that the mass 130 always moves in an opposite axial direction relative to the axial movement of the cone 128, as shown by arrows 186, 188 in FIG. 5. Because the cone 128 and the mass 130 are always moving in opposite axial directions, the reciprocal movement of the cone 128 is always counterbalanced by the reciprocal movement of the mass 130, which effectively reduces or eliminates the net force exerted on the frame 112 during operation of the speaker 100. Reducing or eliminating the net force exerted on the frame 112 helps eliminate vibration of the frame 112 and of any components attached thereto.

In one form, the mass 130 may be controlled to move out of phase relative to the movement of the cone 128 by respectively winding the voice coil 124 and the secondary coil 126 in the same direction around the first and second coil formers 158, 166 and sending inverse variable electrical audio signals to the secondary coil 126 that are 180 degrees out of phase with the variable electrical audio signals sent to the voice coil 124. In another form, the mass 130 may be controlled to move out of phase relative to the movement of the cone 128 by respectively winding the voice coil 124 and the secondary coil 126 is opposite directions around the first and second coil formers 158, 166 and passing the same variable electrical audio signals through the voice coil 124 and the secondary coil 126 at the same time.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A moving coil speaker comprising:
a frame;
a magnet assembly fixedly mounted to the frame and having a central axis, a front end, and an opposite back end, the magnet assembly including an annular permanent magnet disposed around the central axis;
first and second annular gaps concentrically disposed around the central axis, the first annular gap defined by the front end of the magnet assembly and the second annular gap defined by the back end of the magnet assembly;
a voice coil at least partially received within the first annular gap;
a cone coupled to and driven by the voice coil;
a secondary coil coaxial with the voice coil and at least partially received within the second annular gap;
a mass fixedly coupled to and driven by the secondary coil; and
an audio signal source electrically coupled to the voice coil and the secondary coil,
wherein, the audio signal source, the voice coil, and the secondary coil are constructed and arranged such that, when variable electrical audio signals are directed from the audio signal source respectively through the voice coil and the secondary coil, the coils and their respectively associated cone and mass reciprocate back and forth in opposite axial directions, with the reciprocal movement of the cone being counterbalanced by the reciprocal movement of the mass, and
wherein the mass is coincident with the central axis of the magnet assembly.

2. The speaker of claim 1, wherein the voice coil and the secondary coil are wound in opposite directions around respective first and second coil formers, and wherein, the audio signal source is electrically coupled to the voice coil and the secondary coil such that the variable electrical audio signals received by the voice coil are in phase with the variable electrical audio signals received by the secondary coil.

3. The speaker of claim 1, wherein the voice coil and the secondary coil are wound in the same direction around respective first and second coil formers, and wherein, the audio signal source is electrically coupled to the voice coil and the secondary coil such that the variable electrical audio signals received by the voice coil are 180 degrees out of phase with the variable electrical audio signals received by the secondary coil.

4. The speaker of claim 1, wherein the magnet assembly includes a front plate adjacent the front end, a back plate adjacent the back end, a center pole piece extending along the central axis, and a peripheral pole piece extending from the front end toward the back end.

5. The speaker of claim 4, wherein the annular permanent magnet is sandwiched between the front and back plates, the center pole piece is surrounded by the annular permanent magnet and the front plate, and the peripheral pole piece extends around an outer periphery of the annular permanent magnet.

6. The speaker of claim 5, wherein the first annular gap is defined between an inner circumferential surface of the front plate and an outer circumferential surface of the center pole piece and the second annular gap is defined between an inner circumferential surface of the peripheral pole piece and an outer circumferential surface of the back plate such that the second annular gap and the secondary coil are located radially outward of the first annular gap and the voice coil, and wherein the mass is located radially inward of the secondary coil.

7. The speaker of claim 6, wherein magnetic flux generated by the annular permanent magnet travels in a first direction from the magnet, through the back plate, through the center pole piece, across the first annular gap, through the front plate, and back into the magnet, and wherein magnetic flux generated by the annular permanent magnet travels in a second direction opposite the first direction from the magnet, through the back plate, across the second annular gap, through the peripheral pole piece, through the front plate, and back into the magnet.

8. The speaker of claim 6, wherein the center pole piece and the back plate are of integral, one-piece construction, and wherein the peripheral pole piece and the front plate are of integral, one-piece construction.

9. The speaker of claim 1, wherein the magnet assembly includes a front plate adjacent the front end, a back plate adjacent the back end, and a center pole piece including a cylindrical permanent magnet.

10. The speaker of claim 9, wherein the annular permanent magnet is sandwiched between the front and back plates, the center pole piece is surrounded by the annular permanent magnet and the front plate, and the center pole piece includes a first end adjacent the back plate, an opposite second end adjacent the front plate, and a pair of concentric inner and outer pole pieces connected to each other at the second end by a bridge.

11. The speaker of claim 10, wherein the outer pole piece extends from the first end to the second end of the center pole piece and at least partway through the front plate, the inner pole piece extends along the central axis from a proximal end adjacent the second end of the center pole piece to a distal end adjacent the first end of the center pole piece, and wherein the distal end of the inner pole piece extends at least partway through the back plate and the cylindrical permanent magnet is positioned along the central axis between the proximal and distal ends of the inner pole piece.

12. The speaker of claim 11, wherein the first annular gap is defined between an inner circumferential surface of the front plate and an outer circumferential surface of the outer pole piece and the second annular gap is defined between an inner circumferential surface of the outer pole piece and an outer circumferential surface of the inner pole piece such that the second annular gap and the secondary coil are located radially inward of the first annular gap and the voice coil, and wherein the mass is located radially inward of the voice coil.

13. The speaker of claim 12, wherein the center pole piece and the back plate are of integral, one-piece construction,

14. The speaker of claim 12, wherein the cylindrical permanent magnet has the same magnetic orientation as that of the annular permanent magnet.

15. The speaker of claim 14, wherein magnetic flux generated by the annular permanent magnet travels from the annular permanent magnet, through the front plate, across the first annular gap, through the outer pole piece of the center pole piece, through the back plate, and back into the annular permanent magnet, and wherein magnetic flux generated by the cylindrical permanent magnet travels from the cylindrical permanent magnet, through the proximal end of the inner pole piece, through the bridge, through the outer pole piece, across the second annular gap, through the distal end of the inner pole piece, and back into the cylindrical permanent magnet.

16. The speaker of claim 15, wherein the magnetic flux respectively generated by the annular permanent magnet and the cylindrical permanent magnet travels along a shared path through the outer pole piece of the center pole piece.

17. A moving coil speaker comprising:
a frame;
a magnet assembly fixedly mounted to the frame and having a central axis, a front end, and an opposite back end, the magnet assembly including:
an annular permanent magnet disposed around the central axis,
a front plate adjacent the front end,
a back plate adjacent the back end,
a center pole piece extending between the front and back ends along the central axis and at least part-way through a central opening in the front plate, and
first and second annular gaps concentrically disposed around the central axis, the first annular gap defined by the front end of the magnet assembly and the second annular gap defined by the back end of the magnet assembly;
a voice coil at least partially received within the first annular gap;
a cone coupled to and driven by the voice coil;
a secondary coil coaxial with the voice coil and at least partially received within the second annular gap;
a mass fixedly coupled to and driven by the secondary coil; and
an audio signal source electrically coupled to the voice coil and the secondary coil,
wherein the annular permanent magnet is sandwiched between the front and back plates and the center pole piece is surrounded by the annular permanent magnet and the front plate,
wherein, the voice coil and the secondary coil are constructed and arranged such that, when variable electrical audio signals are directed from the audio signal source respectively through the voice coil and the secondary coil, the coils and their respectively associated cone and mass reciprocate back and forth in opposite axial directions, with the reciprocal movement of the cone being counterbalanced by the reciprocal movement of the mass, and
wherein the mass is coincident with the central axis of the magnet assembly.

18. The speaker of claim 17 comprising:
a peripheral pole piece extending around an outer periphery of the annular permanent magnet and extending in an axial direction from the front plate toward the back plate,
wherein the first annular gap is defined between an inner circumferential surface of the front plate and an outer circumferential surface of the center pole piece and the second annular gap is defined between an inner circumferential surface of the peripheral pole piece and an outer circumferential surface of the back plate such that the second annular gap and the secondary coil are located radially outward of the first annular gap and the voice coil, and wherein the mass is located radially inward of the secondary coil,
wherein magnetic flux generated by the annular permanent magnet travels in a first direction through the front and back plates, the center pole piece, and across the first annular gap, and
wherein magnetic flux generated by the annular permanent magnet travels in a second direction opposite the first direction through the front and back plates, the peripheral pole piece, and across the second annular gap.

19. The speaker of claim 17, wherein the magnet assembly comprises a cylindrical permanent magnet, the center pole piece includes a first end adjacent the back plate, an opposite second end adjacent the front plate, and a pair of concentric inner and outer pole pieces extending between the first and second ends, the first annular gap is defined between an inner circumferential surface of the front plate and an outer circumferential surface of the outer pole piece, the second annular gap is defined between an inner circumferential surface of the outer pole piece and an outer circumferential surface of the inner pole piece such that the second annular gap and the secondary coil are located radially inward of the first annular gap and the voice coil and the mass is located radially inward of the voice coil, and wherein the cylindrical permanent magnet is disposed along the central axis between the first and second ends of the center pole piece.

20. The speaker of claim 19, wherein magnetic flux generated by the annular permanent magnet travels through the front and back plates, the outer pole piece of the center pole piece, and across the first annular gap, magnetic flux generated by the cylindrical permanent magnet travels through the inner and outer pole pieces of the center pole piece and across the second annular gap, and wherein the magnetic flux respectively generated by the annular permanent magnet and the cylindrical permanent magnet travels along a shared path through the outer pole piece of the center pole piece.
